(19) United States
(12) Patent Application Publication
(10) Pub. No.: US 2024/0394918 A1
(43) Pub. Date: Nov. 28, 2024

(54) KEYPOINT DETECTION METHOD, TRAINING METHOD, APPARATUS, ELECTRONIC DEVICE, COMPUTER-READABLE STORAGE MEDIUM, AND COMPUTER PROGRAM PRODUCT

(71) Applicant: Tencent technology (Shenzhen) Company Limited, Shenzhen (CN)

(72) Inventor: Weibin QIU, Shenzhen (CN)

(21) Appl. No.: 18/793,553

(22) Filed: Aug. 2, 2024

Related U.S. Application Data
(63) Continuation of application No. PCT/CN2023/129915, filed on Nov. 6, 2023.

(30) Foreign Application Priority Data
Dec. 9, 2022 (CN) 2022/11576832.9

(51) Int. Cl. G06T 7/73; G06T 17/20

(52) U.S. Cl. CPC G06T 7/75; G06T 17/20; G06T 2207/10028; G06T 2207/20084; G06T 2207/30201; G06T 2210/56

(57) ABSTRACT

This application provides a keypoint detection method performed by an electronic device. The method includes: obtaining a three-dimensional mesh configured for representing a target object; performing feature extraction on vertices of the three-dimensional mesh, to obtain a vertex feature; performing global feature extraction on the target object based on the vertex feature, to obtain a global feature, and performing local feature extraction on the target object based on the vertex feature and the connection relationship between the vertices, to obtain a local feature; and obtaining a position of a keypoint of the target object based on the vertex feature, the global feature, and the local feature, to obtain a position of the keypoint of the target object on the target object.

### CROSS-REFERENCE TO RELATED APPLICATIONS

This application is a continuation application of PCT Patent Application No. PCT/CN2023/129915, entitled “KEYPOINT DETECTION METHOD, TRAINING METHOD, APPARATUS, ELECTRONIC DEVICE, COMPUTER-READABLE STORAGE MEDIUM, AND COMPUTER PROGRAM PRODUCT” filed on Nov. 6, 2023, which are based upon and claims priority to Chinese Patent Application No. 202211576832.9, entitled “KEYPOINT DETECTION METHOD, TRAINING METHOD, APPARATUS, ELECTRONIC DEVICE, COMPUTER-READABLE STORAGE MEDIUM, AND COMPUTER PROGRAM PRODUCT” filed on Dec. 9, 2022, both of which are incorporated herein by reference in their entirety.

### FIELD OF THE TECHNOLOGY

This application relates to the field of artificial intelligence technologies, and in particular, to a keypoint detection method, a training method, an apparatus, an electronic device, a computer-readable storage medium, and a computer program product.

### BACKGROUND OF THE DISCLOSURE

In the related art, keypoint detection of a three-dimensional face character is generally divided into two general types. The first general type is a method based on traditional geometric analysis, and the second general type is a method based on deep learning. For the first type of method, a keypoint positioning method based on the geometric analysis relies on manually set rules, and is difficult to be applied to head models of different forms. Therefore, robustness of the method is poor. However, for the second type of method, basically, a three-dimensional head model is first rendered into two-dimensional images, and then a two-dimensional convolutional neural network is used to extract a feature, to detect a corresponding keypoint. As a result, three-dimensional geometric information is inevitably lost. Based on this, accuracy of the keypoint detection of the three-dimensional face character in the related art is low.

### SUMMARY

The embodiments of this application provide a keypoint detection method, a method for training a three-dimensional network model, an apparatus, an electronic device, a computer-readable storage medium, and a computer program product, to improve accuracy of performing keypoint detection through a three-dimensional network model.

Technical solutions of the embodiments of this application are implemented as follows.

An embodiment of this application provides a keypoint detection method performed by an electronic device, the method including:
obtaining a three-dimensional mesh configured for representing a target object;
performing feature extraction on vertices of the three-dimensional mesh, to obtain a vertex feature of the three-dimensional mesh;
performing global feature extraction on the target object based on the vertex feature, to obtain a global feature of the target object, and performing local feature extraction on the target object based on the vertex feature and the connection relationship between the vertices, to obtain a local feature of the target object; and
obtaining a position of a keypoint of the target object on the target object based on the vertex feature, the global feature, and the local feature.

An embodiment of this application provides an electronic device, including:
a processor;
a memory; and
a plurality of computer-executable instructions stored in the memory that, when executed by the processor, cause the electronic device to perform the keypoint detection method according to the embodiments of this application.

An embodiment of this application provides a non-transitory computer-readable storage medium, having computer-executable instructions stored therein. The computer-executable instructions, when executed by a processor of an electronic device, cause the electronic device to perform the keypoint detection method according to the embodiments of this application.

The embodiments of this application have the following beneficial effects:

A three-dimensional mesh corresponding to a target object is obtained, a global feature and a local feature of the target object are separately extracted through construction of a dual-path feature extraction layer based on a vertex feature and a connection relationship between vertices obtained by using the three-dimensional mesh, and then a position of a keypoint on the target object is obtained based on the vertex feature obtained by using the three-dimensional mesh and the global feature and the local feature obtained through extraction. In this way, richer feature information of the target object is extracted via a plurality of feature extraction layers, and then detection is performed on the keypoint of the target object based on the rich feature information, so that accuracy of three-dimensional keypoint detection is significantly improved.

### BRIEF DESCRIPTION OF THE DRAWINGS

FIG. 1 is a schematic architectural diagram of a keypoint detection system 100 according to an embodiment of this application.

FIG. 2 is a schematic structural diagram of an electronic device according to an embodiment of this application.

FIG. 3 is a schematic flowchart of a keypoint detection method according to an embodiment of this application.

FIG. 4 is a schematic diagram of a three-dimensional mesh of a human head according to an embodiment of this application.

FIG. 5 is a schematic flowchart of determining a local feature of each vertex according to an embodiment of this application.

FIG. 6 is a schematic diagram of determining a correlation degree between a reference vertex and another vertex by using an attention mechanism according to an embodiment of this application.

FIG. 7 is a schematic diagram of positions of keypoints on a target object according to an embodiment of this application.

FIG. 8 is a schematic structural diagram of a three-dimensional network model according to an embodiment of this application.

FIG. 9 is a schematic structural diagram of a third feature extraction layer according to an embodiment of this application.

FIG. 10 is a schematic structural diagram of a three-dimensional network model according to an embodiment of this application.

FIG. 11 is a schematic flowchart of a training process of a three-dimensional network model according to an embodiment of this application.

FIG. 12 is a schematic diagram of patch simplification of a three-dimensional mesh according to an embodiment of this application.

FIG. 13 is a schematic diagram of patch densification of a three-dimensional mesh according to an embodiment of this application.

FIG. 14 is a schematic flowchart of a keypoint detection method according to an embodiment of this application.

FIG. 15 is a schematic structural diagram of a graph convolutional neural network according to an embodiment of this application.

FIG. 16 is a comparison diagram of a geodesic distance and a Euclidean distance according to an embodiment of this application.

### DESCRIPTION OF EMBODIMENTS

To make objectives, technical solutions, and advantages of this application clearer, the following further describes the embodiments of this application in detail with reference to the accompanying drawings. The described embodiments are not to be considered as a limitation to the embodiments of this application. All other embodiments obtained by a person of ordinary skill in the art without creative efforts shall fall within the protection scope of this application.

In the following descriptions, the term “some embodiments” describes subsets of all possible embodiments, but “some embodiments” may be the same subset or different subsets of all possible embodiments, and can be combined with each other without conflict.

In the following descriptions, the terms “first”, “second”, and “third” are merely for distinguishing between similar objects rather than representing a specific order of the objects. A specific order or a sequence of “first”, “second”, and “third” is interchangeable in proper circumstances, so that the embodiments of this application described herein can be implemented in an order other than that is illustrated or described herein.

Unless otherwise defined, meanings of all technical and scientific terms used in this specification are the same as those usually understood by a person skilled in the art to which this application belongs. Terms used in this specification are merely intended to describe the objectives of the embodiments of this application, but are not intended to limit this application.

Before the embodiments of this application are further described in detail, nouns and terms in the embodiments of this application are described, and the nouns and the terms in the embodiments of this application are applicable to the following explanations.

(1) Three-dimensional mesh: A three-dimensional mesh is a manifold surface having a topology structure, for example, a spherical surface divided into a combination of a plurality of vertices and a plurality of sides. In this application, the three-dimensional mesh may be a three-dimensional face mesh. Herein, the three-dimensional mesh is a graph structure.

(2) Client: A client is a program that corresponds to a server and that provides a local service for a user. Except for some applications that can only be run locally, the client is generally installed on an ordinary client machine, and needs to be run in cooperation with the server. In other words, a corresponding server and service program need to exist in a network to provide a corresponding service. Therefore, a specific communication connection needs to be established between the client and the server, to ensure normal running of the application.

(3) Three-dimensional face keypoint detection: Three-dimensional face keypoint detection means detecting three-dimensional coordinates of a series of face keypoints with preset semantics given any three-dimensional face mesh model. Quantities of vertices and patches of the three-dimensional face model are not limited. The keypoint with the preset semantic refers to position information of a canthus, a corner of the mouth, a nose tip, a face contour, and the like. The semantic of the keypoint and a quantity of keypoints are determined by a specific task.

(4) Graph neural network (GNN): A GNN is a type of artificial neural network, and is configured for processing data that may be represented as a graph. In comparison with a conventional two-dimensional convolutional neural network acting on a two-dimensional image, the graph neural network expands an acting object into graph data that can be represented in a three-dimensional mesh morphology. A key design element of the graph neural network is to use message pairs for transferring, so that a graph node is iteratively updated by exchanging information with a neighbor of the graph node.

(5) Loss: A loss is configured for measuring a difference between an actual result and a target result of a model, to perform model training and optimization.

(6) Three-dimensional heatmap regression: Three-dimensional heatmap regression means that: A graph neural network uses a heatmap as an output layer, forms a regression loss in combination with a standard heatmap, the neural network is trained through forward propagation and gradient backhaul, so that an output of the neural network is fitted with a label, and keypoint coordinates are finally calculated based on the heatmap.

(7) Three-dimensional (3D) scanner: A 3D scanner is a scientific instrument configured to detect and analyze a shape (geometric structure) and appearance data (characteristics such as a color and a surface albedo) of an object or an environment in the real world. Collected data is usually configured for performing three-dimensional reconstruction calculation, to create digital models of actual objects in the virtual world. These models have a wide range of applications, such as industrial design, defect detection, reverse engineering, robot guidance, landscape measurement, medical information, biological information, and criminal identification.

(8) Multi-layer perceptron (MLP): A multi-layer perceptron is an artificial neural network with a forward structure for mapping a group of input vectors to a group of output vectors. The MLP may be considered as a directed graph, and is formed by a plurality of node layers. Each layer is fully connected to a next layer. Each node other than an input node is a neuron (or referred to as a processing unit) with a non-linear activation function.

(9) Convolutional neural network (CNN): A convolutional neural network is a feedforward neural network, generally formed by one or more convolutional layers (network layers that use convolutional mathematical operation) and a fully connected layer at an end. A neuron inside the network may respond to some regions of an input image, and generally have excellent performance in the field of visual image processing.

(10) Machine learning (ML): Machine learning is a multi-field interdiscipline, and relates to a plurality of disciplines such as the probability theory, statistics, the approximation theory, convex analysis, and the algorithm complexity theory. The machine learning specializes in studying how a computer simulates or implements a human learning behavior to acquire new knowledge or skills, and reorganize an existing knowledge structure, to keep improving its performance. The machine learning is the core of artificial intelligence, is a basic way to make the computer intelligent, and is applied to various fields of the artificial intelligence. The machine learning and deep learning generally include technologies such as an artificial neural network, a belief network, reinforcement learning, transfer learning, inductive learning, and learning from demonstrations.

(11) Point cloud data: Point cloud data is a set of massive points of a surface feature of a target, and is generally obtained through laser measurement or photogrammetry. Point cloud data obtained through laser measurement includes three-dimensional coordinates and laser reflection intensity. Such point cloud data is usually used to determine a state of an object based on an echo characteristic and reflection intensity. Point cloud data obtained through photogrammetry usually includes three-dimensional coordinates and color information.

(12) Graph attention network (GAT): A GAT is a new neural network architecture based on graph structural data.

As the artificial intelligence technology is researched and advanced, researches and applications of the artificial intelligence technology are carried out in a plurality of fields, such as common smart homes, smart wearing devices, virtual assistants, smart speakers, smart marketing, unmanned driving, autonomous driving, drones, robots, smart medicine, and smart customer service. It is believed that as the technology develops, the artificial intelligence technology is to be applied in more fields and play an increasingly important role.

The solutions provided in the embodiments of this application relate to a technology such as a three-dimensional network model of artificial intelligence, and may also be applied to fields such as a cloud technology and Internet of vehicles. Details are specifically described in the following embodiments.

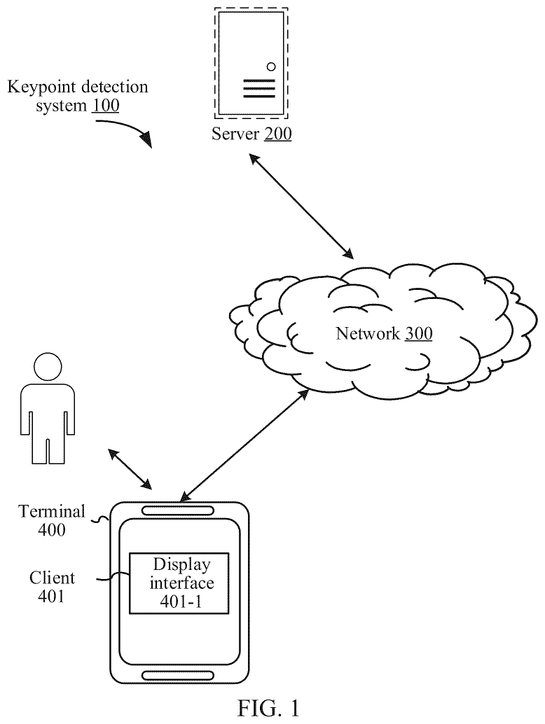

Referring to FIG. 1, FIG. 1 is a schematic architectural diagram of a keypoint detection system 100 according to an embodiment of this application. To implement an application scenario of keypoint detection (for example, the application scenario of the keypoint detection may be: When the keypoint detection is performed on a face, three-dimensional scanning is first performed on the face by using a three-dimensional scanner, and then a position of a keypoint on the face based on three-dimensional scan data is detected), a terminal (for example, a terminal 400 is shown) is connected to a server 200 via a network 300. The network 300 may be a wide area network, a local area network, or a combination thereof. The terminal 400 is configured for a user to perform display on a display interface (for example, a display interface 401-1 is shown) by using a client 401. The terminal 400 and the server 200 are connected to each other via the wired or wireless network.

The terminal 400 is configured to acquire three-dimensional scan data corresponding to a target object and send the three-dimensional scan data to the server 200.

The server 200 is configured to: receive the three-dimensional scan data; obtain, based on the three-dimensional scan data, a three-dimensional mesh configured for representing the target object, and determine vertices of the three-dimensional mesh and a connection relationship between the vertices; perform feature extraction on the vertices of the three-dimensional mesh, to obtain a vertex feature of the three-dimensional mesh; perform global feature extraction on the target object based on the vertex feature, to obtain a global feature of the target object, and perform local feature extraction on the target object based on the vertex feature and the connection relationship between the vertices, to obtain a local feature of the target object; performing detection on a keypoint of the target object based on the vertex feature, the global feature, and the local feature, to obtain a position of the keypoint of the target object on the target object; and send the position of the keypoint on the target object to the terminal 400.

The terminal 400 is further configured to display, based on the display interface, the position of the keypoint on the target object.

In some embodiments, the server 200 may be an independent physical server, may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a set-top box, a smart voice interaction device, a smart home appliance, an in-vehicle terminal, an aircraft, a mobile device (for example, a mobile phone, a portable music player, a personal digital assistant, a dedicated message device, a portable game device, a smart speaker, and a smartwatch), or the like, but is not limited thereto. The terminal device and the server may be directly or indirectly connected in a wired or wireless communication manner. This is not limited in the embodiments of this application.

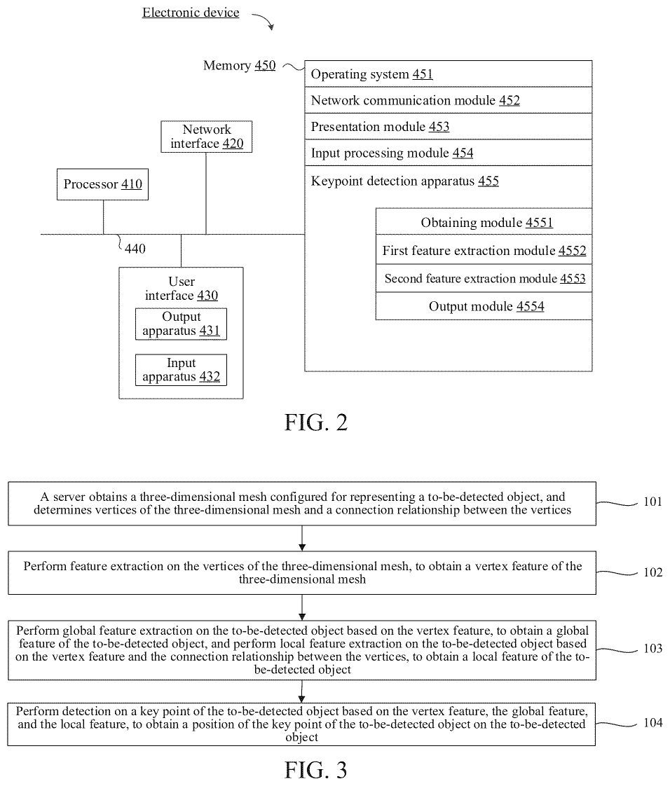

Referring to FIG. 2, FIG. 2 is a schematic structural diagram of an electronic device according to an embodiment of this application. During actual application, the electronic device may be the server 200 or the terminal 400 shown in FIG. 1. Referring to FIG. 2, the electronic device shown in FIG. 2 includes: at least one processor 410, a memory 450, at least one network interface 420, and a user interface 430. All components in the terminal 400 are coupled together by using a bus system 440. The bus system 440 is configured to implement connection and communication between the components. In addition to a data bus, the bus system 440 further includes a power bus, a control bus, and a state signal bus. However, for ease of clear description, all types of buses are marked as the bus system 440 in FIG. 2.

The processor 410 may be an integrated circuit chip having a signal processing capability, for example, a general processor, a digital signal processor (DSP), another programmable logic device, a discrete gate or a transistor logic device, a discrete hardware component, or the like. The general processor may be a microprocessor or any regular processor or the like.

The user interface 430 includes one or more output apparatuses 431 that enable media content to be presented, and the output apparatuses 431 include one or more speakers and/or one or more visual displays. The user interface 430 further includes one or more input apparatuses 432, and the input apparatuses 432 include a user interface component that helps user input, for example, a keyboard, a mouse, a microphone, a touch display, a camera, or another input button or control.

The memory 450 may be a removable memory, a non-removable memory, or a combination thereof. Exemplary hardware devices include a solid-state memory, a hard disk drive, an optical disk drive, and the like. In some embodiments, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in this embodiment of this application aims to include any suitable type of memory.

In some embodiments, the memory 450 can store data to support various operations. Examples of the data include a program, a module, a data structure, or a subset or a superset thereof, which are described below by way of example.

An operating system 451 includes system programs configured to process various basic system services and execute a hardware-related task, for example, a frame layer, a core library layer, and a drive layer, configured to implement various basic services and process the hardware-based task.

A network communication module 452 is configured to reach another electronic device through the one or more (wired or wireless) network interfaces 420. Exemplary network interfaces 420 include: Bluetooth, wireless fidelity (Wi-Fi), a universal serial bus (USB), and the like.

A presentation module 453 is configured to enable, through the one or more output apparatuses 431 (for example, a display screen and a speaker) associated with the user interface 430, information to be presented (for example, configured to operate a peripheral device and a user interface displaying content and information).

An input processing module 454 is configured to detect user input or interaction from the one or more input apparatuses 432 and translate the detected input or interaction.

In some embodiments, the apparatus provided in the embodiments of this application may be implemented in a software manner. FIG. 2 shows a keypoint detection apparatus 455 stored in the memory 450. The keypoint detection apparatus 455 may be software in a form of a program, a plug-in, or the like, including the following software modules: an obtaining module 4551, a first feature extraction module 4552, a second feature extraction module 4553, and an output module 4554. These modules are logical, and therefore may be arbitrarily combined or further divided based on an implemented function. Functions of the modules are described below.

In some other embodiments, the apparatus provided in the embodiments of this application may be implemented in a hardware manner. In an example, the keypoint detection apparatus provided in the embodiments of this application may be a processor in a form of a hardware decoding processor, and the processor is programed to perform a keypoint detection method provided in the embodiments of this application. For example, the processor in the form of the hardware decoding processor may be implemented by using one or more application-specific integrated circuits (ASIC), a DSP, a programmable logic device (PLD), a complex programmable logic device (CPLD), a field programmable gate array (FPGA), or another electronic element.

In some embodiments, the terminal or the server may implement the keypoint detection method provided in the embodiments of this application by running a computer program. For example, the computer program may be a native program or a software module in the operating system; may be a native application (APP), namely, a program that needs to be installed in the operating system to run, such as an instant messaging APP or a web browser APP; may be an applet, namely, a program that only needs to be downloaded into a browser environment to run; or may be an applet that can be embedded into any APP. In summary, the foregoing computer program may be any form of an application, a module, or a plug-in.

Based on the foregoing descriptions of the keypoint detection system and the electronic device provided in the embodiments of this application, the keypoint detection method provided in the embodiments of this application is described below. During actual implementation, the keypoint detection method provided in the embodiments of this application may be implemented by a terminal or a server separately, or by the terminal and the server together. An example in which the server 200 in FIG. 1 independently performs the keypoint detection method provided in the embodiments of this application is used for description. Referring to FIG. 3, FIG. 3 is a schematic flowchart of a keypoint detection method according to an embodiment of this application. Operations shown are described below with reference to FIG. 3.

Operation 101: A server obtains a three-dimensional mesh configured for representing a target object, and determines vertices of the three-dimensional mesh and a connection relationship between the vertices.

During actual implementation, obtaining a three-dimensional mesh configured for representing a target object may be directly receiving a three-dimensional mesh of a target object sent by another device, or may be implemented by using point cloud data (namely, three-dimensional scan data) corresponding to the target object. Herein, the point cloud data is configured for indicating a set of massive points of a surface feature of the target object, and may generally be obtained through laser measurement or photogrammetry. Specifically, the point cloud data corresponding to the target object is first acquired, and then the three-dimensional mesh configured for representing the target object is obtained based on the point cloud data, in other words, the three-dimensional mesh corresponding to the target object is constructed. Herein, there are a plurality of manners of acquiring the point cloud data corresponding to the target object. The point cloud data may be prestored locally in a terminal, may be acquired from the outside world (such as the Internet), or may be collected in real time, for example, collected in real time by using a three-dimensional scanning apparatus such as a three-dimensional scanner.

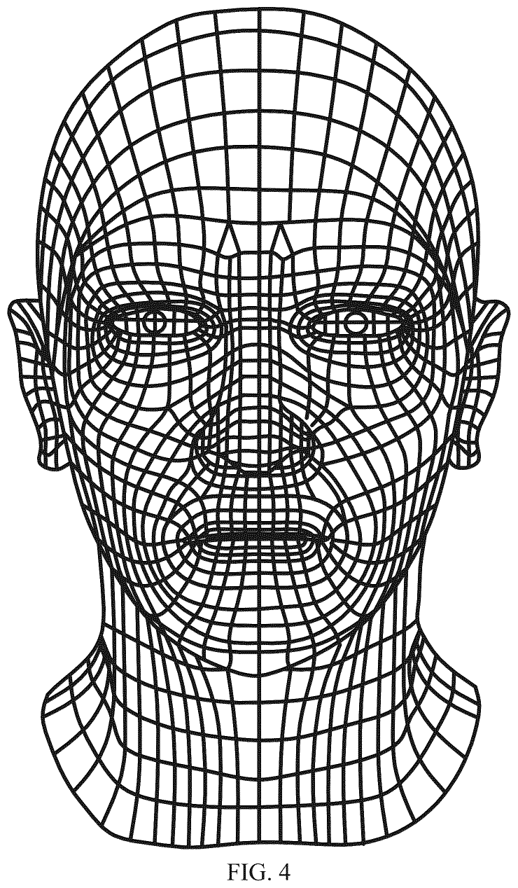

In some embodiments, when the point cloud data is collected in real time by using the three-dimensional scanning apparatus such as the three-dimensional scanner, a process of constructing the three-dimensional mesh corresponding to the target object specifically includes: scanning the target object by using the three-dimensional scanning apparatus, to obtain point cloud data of a geometric surface of the target object; and constructing the three-dimensional mesh corresponding to the target object based on the point cloud data. For example, referring to FIG. 4, FIG. 4 is a schematic diagram of a three-dimensional mesh of a human head according to an embodiment of this application. Based on FIG. 4, when the target object is a face, the three-dimensional scanner performs three-dimensional scanning on the human head, to obtain point cloud data corresponding to the head; and the three-dimensional mesh corresponding to the head is constructed based on the point cloud data.

A process of constructing the three-dimensional mesh corresponding to the target object based on the point cloud data may be as follows: First, the point cloud data is preprocessed to obtain target point cloud data. The preprocessing includes operations such as filtering, denoising, and point cloud registration. Herein, the filtering may remove noise points, the denoising may further reduce noise and invalid points, and the point cloud registration may align the point cloud data into a same coordinate system. Then, mesh reconstruction is performed on the target point cloud data, to obtain the three-dimensional mesh. The mesh reconstruction is a process of transforming discrete target point cloud data into a three-dimensional mesh. Commonly used mesh reconstruction algorithms include a mesh-based method, a voxel-based method, an implicit function-based method, and the like. Herein, the mesh-based method is to transform the target point cloud data into a triangular mesh, the voxel-based method is to transform the target point cloud data into a voxel mesh, and the implicit function-based method is to use a data function to represent the three-dimensional mesh.

In the embodiments of this application, data related to real-time scanning or the like is included. When the embodiments of this application are applied to a specific product or technology, user permission or consent needs to be obtained, and collection, use, and processing of relevant data need to comply with relevant laws, regulations, and standards of relevant countries and regions.

During actual implementation, the connection relationship between the vertices of the three-dimensional mesh may be an inter-vertex connection relationship matrix, configured for indicating whether there is an association between the vertices. A size of the matrix is N*N, and a value of the matrix is 0 or 1. N herein is a quantity of vertices. When a vertex i is connected to a vertex j, a connection relationship Aᵢⱼ between the two vertices is 1, or otherwise, is 0.

For example, on a face, there is a connection relationship between vertices of a three-dimensional mesh configured for indicating a position of an eye, and there is no connection relationship between a vertex of the three-dimensional mesh configured for indicating the position of the eye and a vertex of a three-dimensional mesh for indicating a position of a chin.

Operation 102: Perform feature extraction on the vertices of the three-dimensional mesh, to obtain a vertex feature of the three-dimensional mesh.

During actual implementation, the feature extraction is performed on the vertices of the three-dimensional mesh, to obtain the vertex feature of the three-dimensional mesh. The vertex feature includes positions of the corresponding vertices and information about corresponding positions indicated by the corresponding vertices on a face. For example, the vertex feature herein may be N*(6+X), where N represents a quantity of vertices corresponding to the three-dimensional mesh; 6 represents dimensions occupied by vertex coordinates and a normal vector, to be specific, six direction dimensions corresponding to three coordinate dimensions of vertex coordinates (x, y, z); and X includes other characteristics of the vertices of the three-dimensional mesh, to be specific, the information about the corresponding positions indicated by the corresponding vertices on the face, such as a curvature and texture information. These other characteristics may be adjusted based on different data and tasks. In this way, when this application is applied to a model, in a training phase of the model, these other characteristics are added to improve learning efficiency of the model.

Operation 103: Perform global feature extraction on the target object based on the vertex feature, to obtain a global feature of the target object, and perform local feature extraction on the target object based on the vertex feature and the connection relationship between the vertices, to obtain a local feature of the target object.

After determining the connection relationship between the vertices of the three-dimensional mesh and the vertex feature of the three-dimensional mesh, the global feature extraction and the local feature extraction are separately performed on the target object, to obtain the global feature and the local feature of the target object.

In some embodiments, a process of performing global feature extraction on the target object based on the vertex feature to obtain the global feature of the target object may be: first performing feature extraction on the target object based on the vertex feature; performing max pooling processing on an extracted feature, to obtain a max pooling feature, so that all vertices share the max pooling feature; and using the max pooling feature as the global feature of the target object.

In some embodiments, a process of performing local feature extraction on the target object based on the vertex feature and the connection relationship between the vertices to obtain the local feature of the target object may be: determining a local feature of each vertex based on the vertex feature and the connection relationship between the vertices; and determining the local feature of the target object based on the local feature of each vertex.

Herein, the global feature is configured for indicating overall features of the target object, such as a color feature, a texture feature, and a shape feature of the target object, and the local feature is configured for indicating detailed features of the target object, in other words, features extracted from a local region of the target object, such as features extracted from an edge, a corner, a point, a line, a curve, and a region of a special attribute of the target object. For example, when the target object is the face, the global feature may be a size, a shape, a position, and the like of facial features on the face, and the local feature may be distribution of facial muscles, a shape change of the facial features, and the like under different expressions. Herein, the global feature is a low-layer visual feature at a pixel level. Therefore, the global feature has characteristics such as good invariance, simple calculation, and intuitive representation, but is not applicable to cases of object aliasing and obstruction. The local image feature has characteristics of being rich in number in an image and a small inter-feature correlation degree. In the cases of object aliasing and obstruction, disappearance of some features does not affect detection and matching of other features. In this way, the global feature extraction and the local feature extraction are performed on the target object, to acquire richer and more accurate features of the target object, thereby improving accuracy of a keypoint detection result.

Next, a process of determining the local feature of each vertex based on the vertex feature and the connection relationship between the vertices, and a process of determining the local feature of the target object based on the local feature of each vertex are described separately.

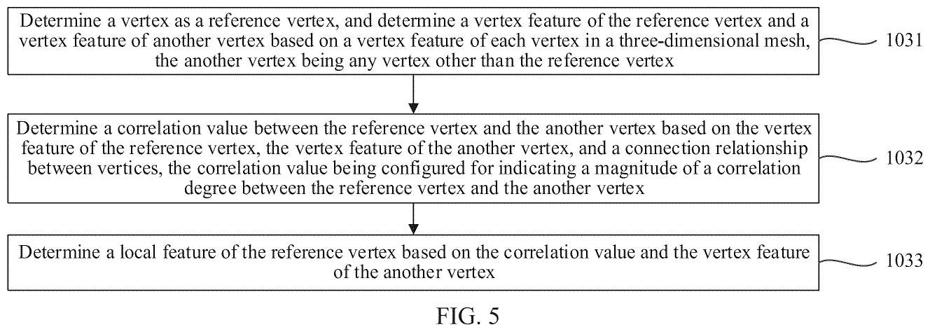

For the process of determining the local feature of each vertex based on the vertex feature and the connection relationship between the vertices, refer to FIG. 5 herein. FIG. 5 is a schematic flowchart of determining the local feature of each vertex according to an embodiment of this application. Based on FIG. 5, the process of determining the local feature of each vertex based on the vertex feature and the connection relationship between the vertices is implemented through operation 1031 to operation 1033. With reference to FIG. 5, the following processing is performed for each vertex.

Operation 1031: Determine the vertex as a reference vertex, and determine a vertex feature of the reference vertex and a vertex feature of another vertex based on a vertex feature of each vertex in a three-dimensional mesh, another vertex being any vertex other than the reference vertex.

For example, the quantity of vertices in the three-dimensional mesh is N, a feature of each vertex is h, and a dimension is F. That is,

$$h = \{ {h}_{1} , {h}_{2} , … , {h}_{N} \} , h ∈ {R}^{F} . \qquad Formula ( 1 )$$

A vertex i is used as a reference node, and hᵢ is a vector with a size of F, that is, a feature of the reference node i. A vertex j is another vertex, and hⱼ is a vector with a size of F, that is, a feature of another node j. There is an edge connection relationship between the vertex i and the vertex j.

Operation 1032: Determine a correlation value between the reference vertex and another vertex based on the vertex feature of the reference vertex, the vertex feature of the another vertex, and the connection relationship between the vertices, the correlation value being configured for indicating a correlation degree between the reference vertex and the another vertex.

In some embodiments, a process of determining the correlation value between the reference vertex and the another vertex based on the vertex feature of the reference vertex, the vertex feature of the another vertex, and the connection relationship between the vertices may be: determining the correlation degree between the reference vertex and the another vertex by using an attention mechanism based on the vertex feature of the reference vertex, the vertex feature of the another vertex, and the connection relationship between the vertices. The correlation degree is an indicator for measuring correlation strength between the reference vertex and another vertex, and a magnitude of the correlation degree may be calculated by using the following formula:

$${e}_{ij} = Attention ( {Wh}_{i} , {Wh}_{j} ) . \qquad Formula ( 2 )$$

W is a weight matrix with a size of F×F, and hᵢ is a vertex feature of a reference vertex i, hⱼ is a vertex feature of another vertex j, attention indicates processing by using an attention mechanism, and eᵢⱼ indicates a correlation degree between the reference vertex and the another vertex.

In some other embodiments, a process of determining the correlation value between the reference vertex and the another vertex based on the vertex feature of the reference vertex, the vertex feature of the another vertex, and the connection relationship between the vertices may be: determining, based on the connection relationship between the vertices, the reference vertex and another vertex that are connected to each other; performing similarity matching on the reference vertex and the corresponding another vertex based on the vertex feature of the reference vertex and a vertex feature of the another vertex that is connected to the reference vertex, to obtain a similarity between the reference vertex and the corresponding another vertex (a corresponding similarity is obtained for each of the another vertex); and determining the similarity as the correlation degree between the reference vertex and the corresponding another vertex.

Then, normalization processing is performed on the correlation degree, to obtain the correlation value between the reference vertex and another vertex. That is,

$${α}_{ij} = {Softmax}_{j} ( {e}_{ij} ) = \frac{exp ( {e}_{ij} )}{{\sum }_{q ∈ {N}_{i}} exp ( {e}_{iq} )} . \qquad Formula ( 3 )$$

Soft maxⱼ indicates that normalization processing is used, αᵢⱼ indicates a correlation value between nodes i and j, exp indicates an exponential function with a natural constant e as the base, Nᵢ indicates a domain formed by all other nodes that have a connection relationship with the reference node i, and q represents any vertex in the domain.

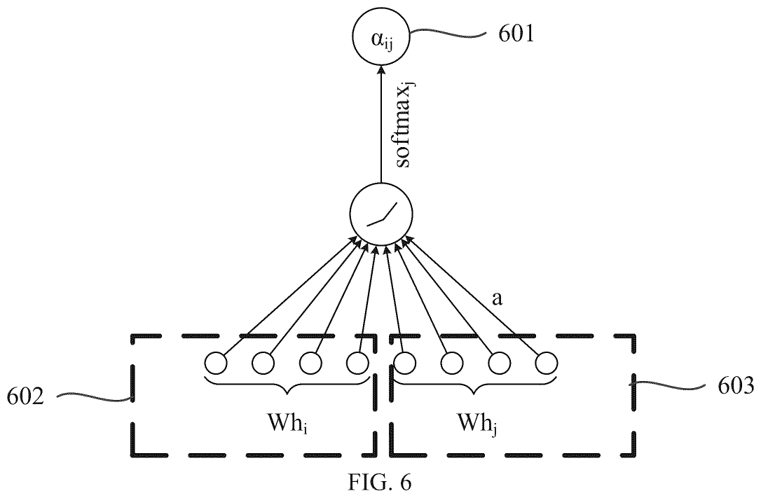

For example, referring to FIG. 6, FIG. 6 is a schematic diagram of determining the correlation degree between the reference vertex and another vertex by using the attention mechanism according to an embodiment of this application. Based on FIG. 6, αᵢⱼ indicated by 601 indicates the correlation value between nodes i and j, Whᵢ in a dashed box 602 indicates the corresponding vertex feature of the reference vertex i, Whⱼ in a dashed box 603 indicates the vertex feature corresponding to the another vertex j, and a is a weight vector. After determining of the correlation degree between the reference vertex and the another vertex based on Whᵢ and Whⱼ, Soft maxⱼ processing, namely, the normalization processing, is performed on the correlation degree, to obtain the correlation value between the reference vertex and the another vertex.

Herein, a process of determining the correlation degree between the reference vertex and the another vertex by using the attention mechanism herein may specifically be: splicing the features Whᵢ and Whⱼ of the vertices i and j, calculating an inner product based on a feature obtained through splicing and a weight vector a with a dimension of 2F, and obtaining the correlation value between the reference vertex and the another vertex through an activation function. That is,

$${α}_{ij} = {Softmax}_{j} ( {e}_{ij} ) = \frac{exp ( LeakyReLU ( {a}^{T} [ {Wh}_{i} ‖ {Wh}_{j} ] ) )}{{\sum }_{q ∈ {N}_{i}} exp ( LeakyReLU ( {a}^{T} [ {Wh}_{i} ‖ {Wh}_{q} ] ) )} . \qquad Formula ( 4 )$$

Nᵢ indicates a domain formed by all other nodes that have a connection relationship with a reference node i, q represents any vertex in the domain, Whᵢ∥Whⱼ indicates a spliced feature obtained by splicing features Whᵢ and Whⱼ of vertices i and j, exp indicates an exponential function with a natural constant e as the base, LeakyReLU is a non-linear activation function, and a is a weight vector with a size of 2F.

For a method for determining the correlation degree, the correlation degree between the reference vertex and another vertex may alternatively be directly calculated based on the vertex feature of the reference vertex, the vertex feature of the another vertex, and the connection relationship between the vertices. There are a plurality of methods for calculating the correlation degree, such as a Pearson correlation coefficient and a Spearman's rank correlation coefficient.

Operation 1033: Determine a local feature of the reference vertex based on the correlation value and the vertex feature of another vertex.

During actual implementation, after the correlation value is obtained, when a quantity of other vertices is one, a process of determining the local feature of the reference vertex based on the correlation value and the vertex feature of the another vertex may be: performing multiplication on the correlation value and the vertex feature of the another vertex, to obtain a multiplication result; and determining the local feature corresponding to the reference vertex based on the multiplication result. That is,

$${h}_{i}^{′} = {σα}_{ij} {Wh}_{j} . \qquad Formula ( 5 )$$

σ is an activation function, αᵢⱼ is a correlation value between a reference vertex i and another vertex j, Whⱼ indicates a vertex feature corresponding to the another vertex j, and hᵢ′ is a local feature corresponding to the reference vertex.

When a quantity of other vertices is more than one, a process of determining the local feature of the reference vertex based on the correlation value and the vertex feature of the another vertex may be: performing, for each of the other vertices, multiplication on the correlation value and a vertex feature of the another corresponding vertex, to obtain a multiplication result of the another vertex; performing cumulative summation on multiplication results of the other vertices, to obtain a summation result; and determining the local feature corresponding to the reference vertex based on the summation result. That is,

$${h}_{i}^{′} = σ ( {\sum }_{j ∈ {N}_{i}} {α}_{ij} {Wh}_{j} ) . \qquad Formula ( 6 )$$

σ is an activation function, αᵢⱼ is a correlation value between a reference vertex i and another vertex j, Whⱼ indicates a vertex feature corresponding to the another vertex j, and Nᵢ indicates a domain formed by all other nodes that have a connection relationship with the reference node i.

A process of determining the local feature of the target object based on the local feature of each vertex specifically includes: performing feature fusion on the local feature of each vertex based on the local feature of each vertex, to obtain a fused feature; and using the fused feature as the local feature of the target object.

Operation 104: Perform detection on a keypoint of the target object based on the vertex feature, the global feature, and the local feature, to obtain a position of the keypoint of the target object on the target object.

In some embodiments, a process of performing detection on the keypoint of the target object based on the vertex feature, the global feature, and the local feature to obtain the position of the keypoint of the target object on the target object may be: performing feature splicing on the vertex feature, the global feature, and the local feature, to obtain a spliced feature of the target object; and performing detection on the keypoint of the target object based on the spliced feature, to obtain the position of the keypoint of the target object on the target object. In this way, the spliced feature includes feature information of the vertex feature, the global feature, and the local feature of the target object, and detection is performed on the keypoint of the target object based on the spliced feature. Therefore, with reference to the feature information of the vertex feature, the global feature, and the local feature, in other words, through richer feature information, the keypoint of the target object is detected, thereby improving accuracy of a keypoint detection result.

In a method based on three-dimensional coordinate regression in the related art, a point around the keypoint may be similar to the keypoint, and therefore, it is difficult to accurately define the keypoint through a pixel position. A three-dimensional heatmap in this application is a statistical chart that displays a plurality of pieces of data by coloring a color block, in other words, displays each piece of data according to a specified color mapping rule. For example, a large value is represented by a dark color, and a small value is represented by a light color; or a large value is represented by a warm tone, and a small value is represented by a cold tone. In this way, the three-dimensional heatmap is outputted, and a probability that the keypoint belongs to each vertex is displayed, so that local accuracy of a detection result can be better ensured.

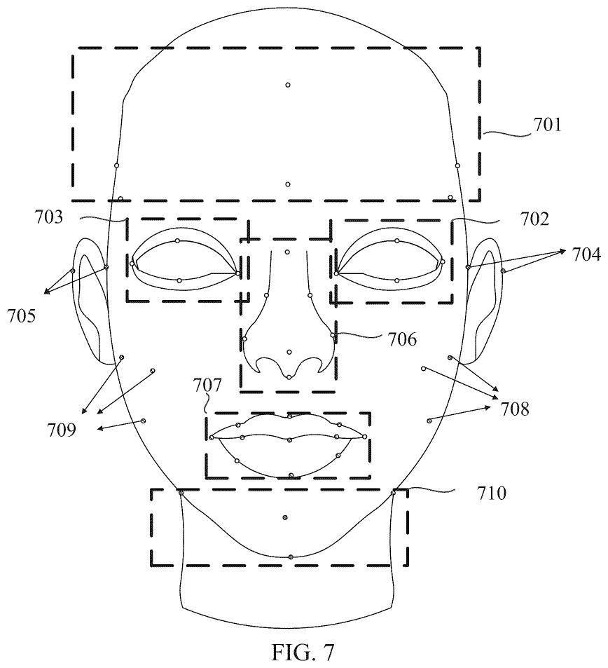

For example, referring to FIG. 7, FIG. 7 is a schematic diagram of positions of keypoints on the target object according to an embodiment of this application. Based on FIG. 7, black points in FIG. 7 are the keypoints. When the target object is the face, the positions of the keypoints shown in FIG. 7 may be positions of facial features of the face. Black points in a dashed box 701 are keypoints indicating a position of a frontal head in the face, black points in dashed boxes 702 and 703 are keypoints indicating positions of eyes in the face, black points indicated by 704 and 705 are keypoints indicating positions of ears in the face, black points in a dashed box 706 are keypoints indicating a position of a nose in the face, black points in a dashed box 707 are keypoints indicating a position of a mouth in the face, black points indicated by 708 and 709 are keypoints indicating positions of cheeks in the face, and black points in the dashed box 710 are keypoints indicating a position of a chin in the face. Herein, detection is performed on the positions of the facial features of the target object via a output layer based on the vertex feature, the global feature, and the local feature, to obtain a probability of a keypoint being at each vertex in the three-dimensional mesh, namely, a probability that each vertex in the three-dimensional mesh is a keypoint corresponding to a position of each facial feature; a three-dimensional heatmap corresponding to the three-dimensional mesh based on each probability is generated; the position of the keypoint of the target object on the target object is determined based on the three-dimensional heatmap. To be specific, for the keypoint corresponding to the position of each facial feature, a vertex with a maximum probability is selected from a plurality of probabilities and determined as the corresponding keypoint, to determine the position of the facial feature based on the obtained keypoint.

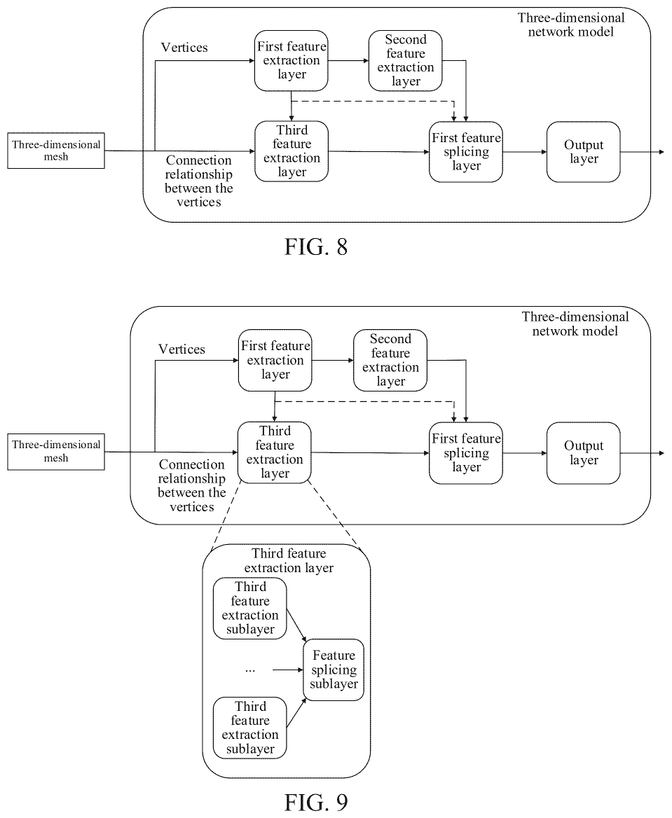

In some embodiments, the keypoint detection method herein may be further applied to a three-dimensional network model. The three-dimensional network model includes at least a first feature extraction layer, a second feature extraction layer, a third feature extraction layer, and an output layer. Referring to FIG. 8, FIG. 8 is a schematic structural diagram of the three-dimensional network model according to an embodiment of this application. Based on FIG. 8, a process of performing feature extraction on the vertices of the three-dimensional mesh to obtain a vertex feature of the three-dimensional mesh may be: performing feature extraction on the vertices of the three-dimensional mesh via the first feature extraction layer, to obtain the vertex feature of the three-dimensional mesh. A process of performing global feature extraction on the target object based on the vertex feature to obtain a global feature of the target object, and performing local feature extraction on the target object based on the vertex feature and the connection relationship between the vertices to obtain a local feature of the target object may be: performing global feature extraction on the target object based on the vertex feature via the second feature extraction layer, to obtain the global feature of the target object; and performing local feature extraction on the target object based on the vertex feature and the connection relationship between the vertices via the third feature extraction layer, to obtain the local feature of the target object. A process of performing detection on the keypoint of the target object based on the vertex feature, the global feature, and the local feature, to obtain the position of the keypoint of the target object on the target object may be: detecting the keypoint of the target object via the output layer based on the vertex feature, the global feature, and the local feature, to obtain the position of the keypoint of the target object on the target object.

In this way, the position of the keypoint on the target object is detected through the three-dimensional network model, so that accuracy of the detected position is improved.

In some embodiments, the third feature extraction layer herein may include at least two third feature extraction sublayers and a feature splicing sublayer. For example, referring to FIG. 9, FIG. 9 is a schematic structural diagram of the third feature extraction layer according to an embodiment of this application. Based on FIG. 9, a process of determining the local feature of each vertex based on the vertex feature and the connection relationship between vertices via the third feature extraction layer may be: performing the following processing for each of the vertices via each of the third feature extraction sublayers: determining the vertex as the reference vertex, and determining the vertex feature of the reference vertex and the vertex feature of the another vertex based on the vertex feature of each vertex in the three-dimensional mesh; determining the correlation value between the reference vertex and the another vertex based on the vertex feature of the reference vertex, the vertex feature of the another vertex, and the connection relationship between the vertices; determining a local subfeature of the reference vertex based on the correlation value and the vertex feature of the another vertex; and splicing the local subfeature obtained through each third feature extraction sublayer via the feature splicing sublayer, to obtain the local feature of the reference vertex. That is,

$${h}_{i}^{′} = concat ( σ ( {\sum }_{j ∈ {N}_{i}} {α}_{ij}^{k} {W}^{k} {h}_{j} ) ) . \qquad Formula ( 7 )$$

k is a quantity of layers of a third feature extraction sublayer, Nᵢ indicates a domain formed by all other nodes that have a connection relationship with a reference node i, σ is an activation function, αᵢⱼ is a correlation value between the reference vertex i and another vertex j, Whⱼ indicates a vertex feature corresponding to the another vertex j, and concat indicates that splicing processing is used.

Herein, a process of determining the correlation value between the reference vertex and another vertex based on the vertex feature of the reference vertex, the vertex feature of the another vertex, and the connection relationship between the vertices is the same as the foregoing process. In addition, a process of determining the local subfeature of the reference vertex based on the correlation value and the vertex feature of another vertex is the same as the foregoing process of determining the local feature of the reference vertex based on the correlation value and the vertex feature of the another vertex. Details are not described herein again.

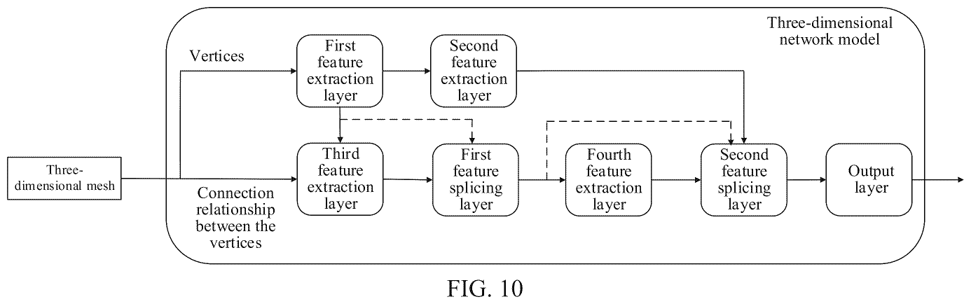

In some embodiments, the three-dimensional network model further includes a first feature splicing layer, a second feature splicing layer, and a fourth feature extraction layer. For example, referring to FIG. 10, FIG. 10 is a schematic structural diagram of the three-dimensional network model according to an embodiment of this application. Based on FIG. 10, a process of performing detection on the keypoint of the target object via the output layer based on the vertex feature, the global feature, and the local feature to obtain the position of the keypoint of the target object may be: performing feature splicing on the vertex feature, the global feature, and the local feature via the first feature splicing layer, to obtain the spliced feature of the target object; performing local feature extraction on the target object based on the spliced feature via the fourth feature extraction layer, to obtain a target local feature of the target object; performing feature splicing on the spliced feature, the global feature, and the target local feature via the second feature splicing layer, to obtain a target spliced feature of the target object; and performing detection on the keypoint of the target object based on the target spliced feature via the output layer, to obtain the position of the keypoint of the target object on the target object.

The three-dimensional network model may further include a fifth feature extraction layer and a third feature splicing layer. Therefore, local feature extraction is performed on the target object based on the target spliced feature via the fifth feature extraction layer, to obtain a second target local feature; then feature splicing is performed on the target spliced feature, the second target local feature, and the global feature via the third feature splicing layer, to obtain a second target spliced feature; and finally detection is performed on the keypoint of the target object based on the second target spliced feature via the output layer, to obtain the position of the keypoint of the target object on the target object. Herein, for a process of determining the local feature and the corresponding spliced feature of the target object in the three-dimensional network model, quantities of feature extraction layers and feature splicing layers in the three-dimensional network model may be more than one, and a process of obtaining the final spliced feature via the plurality of feature extraction layers and feature splicing layers is as described in the foregoing. Details are not described in this embodiment of this application.

Layer structures of the fourth feature extraction layer, the fifth feature extraction layer, and the third feature extraction layer are the same, and processes of processing the features are the same. Layer structures of the second feature splicing layer, the third feature splicing layer, and the first feature splicing layer are the same, and processes of processing the features are also the same. Further feature processing is performed on the spliced feature via the fourth feature extraction layer, to obtain the more accurate target local feature, and the feature splicing is performed on the spliced feature, the global feature, and the obtained target local feature via the second feature splicing layer, to perform detection on the keypoint of the target object based on the target spliced feature obtained by feature splicing. Correspondingly, further feature processing is performed on the target spliced feature via the fifth feature extraction layer, to obtain the more accurate second target local feature, and the feature splicing is performed on the target spliced feature, the global feature, and the obtained second target local feature via the third feature splicing layer, to perform detection on the keypoint of the target object based on the second target spliced feature obtained by feature splicing.

In this way, feature extraction layers with a same structure and feature splicing layers with a same structure are disposed, and a process of performing local feature extracting and corresponding feature splicing on a target object is repeated for a plurality of times, so that accuracy of an extracted feature is improved, thereby improving accuracy of a keypoint detection result.

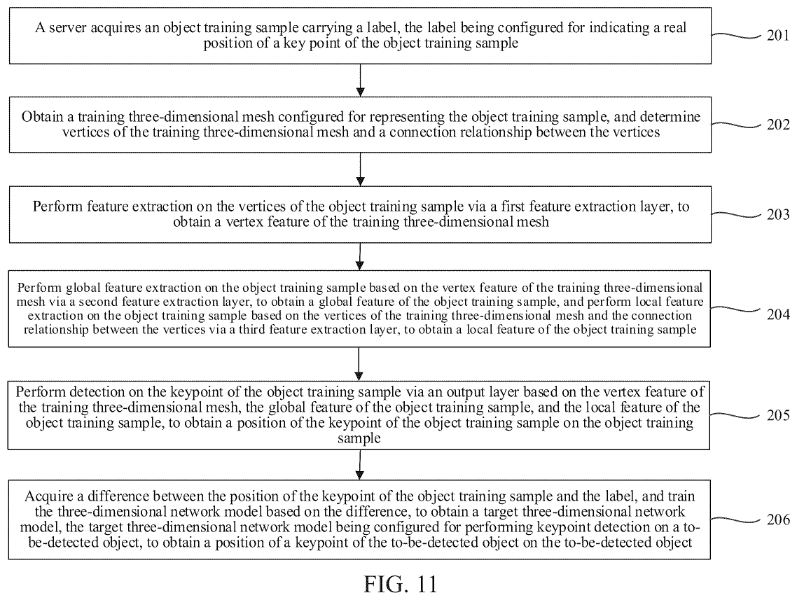

In some embodiments, before detection is performed on the keypoint of the target object based on the three-dimensional network model, the three-dimensional network model further needs to be trained, so that the keypoint of the target object is detected based on a trained three-dimensional network model. Specifically, referring to FIG. 11, FIG. 11 is a schematic flowchart of a training process of a three-dimensional network model according to an embodiment of this application. Based on FIG. 11, the training process of the three-dimensional network model may be implemented through the following operations.

Operation 201: A server acquires an object training sample carrying a label, the label being configured for indicating a real position of a keypoint of the object training sample.

Operation 202: Obtain a training three-dimensional mesh configured for representing the object training sample, and determine vertices of the training three-dimensional mesh and a connection relationship between the vertices.

After the training three-dimensional mesh configured for representing the object training sample is obtained, data enhancement may be further performed on the training three-dimensional mesh, so that the three-dimensional network model is trained through an enhanced training three-dimensional mesh. Specifically, a data enhancement method for the training three-dimensional mesh is divided into patch simplification and patch densification.

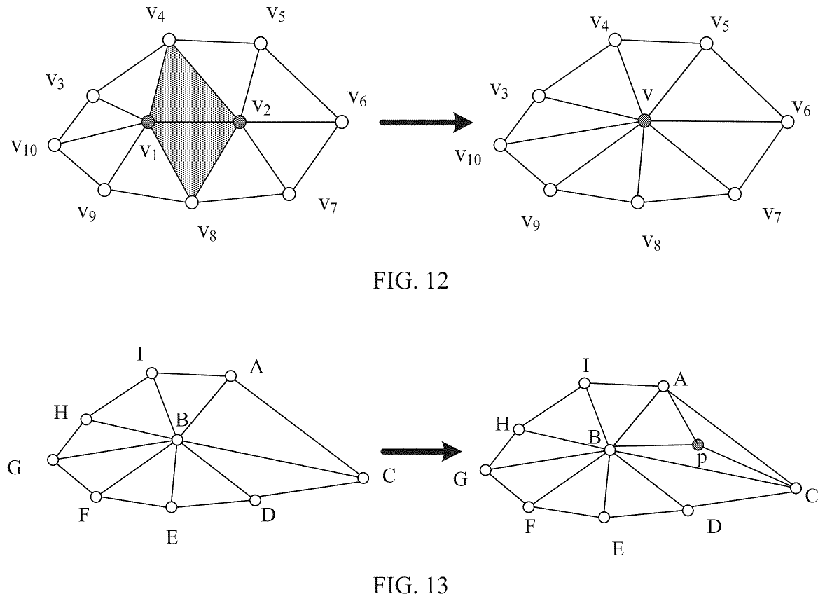

In some embodiments, when the patch simplification is performed on the training three-dimensional mesh, an edge optimization manner may be used. To be specific, the smallest edge between the vertices is found each time, and corresponding two vertices are merged into one vertex. Specifically, an edge between any two vertices is acquired, and edges are compared, to select the smallest edge from the edges as a target edge based on a comparison result; and then two vertices corresponding to the target edge are acquired, and the two vertices are merged into one vertex, to obtain the enhanced training three-dimensional mesh. For example, referring to FIG. 12, FIG. 12 is a schematic diagram of patch simplification of a three-dimensional mesh according to an embodiment of this application. Based on FIG. 12, there are ten vertices v₁ to v₁₀, and based on the ten vertices, ten sides v₁v₂, v₁v₃, v₁v₄, v₁v₁₀, v₁v₉, v₁v₂, v₁v₈, v₅v₂, v₇v₂, and v₀v₂ are formed. An edge between v₁ and v₂ is the smallest edge, and then the two vertices are merged into one vertex v, to obtain an enhanced training three-dimensional mesh.

In some other embodiments, when the patch densification is performed on the training three-dimensional mesh, barycentric coordinates are preferentially calculated for a patch with a large area, and then the original triangular patch is divided into three parts based on the barycentric coordinates. Specifically, at least one patch is acquired, and comparison is performed on the patch. Based on a comparison result, a patch with the largest area is selected from the plurality of patches as a target patch. A center of gravity of the target patch and three vertices corresponding to the target patch are determined, and then the original triangular patch is divided into three parts based on barycentric coordinates and the three vertices. For example, referring to FIG. 13, FIG. 13 is a schematic diagram of patch densification of a three-dimensional mesh according to an embodiment of this application. Based on FIG. 13, there are nine vertices A to I, and based on the nine vertices, eight triangular patches are formed, to be specific, a patch between the vertices A, B, and C, a patch between the vertices A, B, and I, a patch between the vertices H, B, and I, a patch between the vertices H, B, and G, a patch between the vertices F, B, and G, a patch between the vertices F, B, and E, a patch between the vertices D, B, and E, and a patch between the vertices D, B, and C. Herein, the patch between the vertices A, B, and C is a target patch with a largest area. A center of gravity P of the target patch and the corresponding vertices A, B, and C are determined, and then the original target patch is divided into three parts based on P, A, B, and C, to obtain an enhanced training three-dimensional mesh.

Herein, a target quantity of vertices may be preset, to end a data enhancement process of the training three-dimensional mesh. Specifically, in the data enhancement process of the training three-dimensional mesh, a quantity of vertices of the enhanced training three-dimensional mesh is acquired, the quantity of vertices is compared with the preset target quantity of vertices, and the data enhancement of the training three-dimensional mesh is ended based on a comparison result. Herein, when the patch simplification is performed on the training three-dimensional mesh, when the comparison result represents that the quantity of vertices is less than the target quantity of vertices, the data enhancement of the training three-dimensional mesh is ended. When the patch densification is performed on the training three-dimensional mesh, when the comparison result represents that the quantity of vertices is greater than the target quantity of vertices, the data enhancement of the training three-dimensional mesh is ended.

Operation 203: Perform feature extraction on the vertices of the object training sample via a first feature extraction layer, to obtain a vertex feature of the training three-dimensional mesh.

Operation 204: Perform global feature extraction on the object training sample based on the vertex feature of the training three-dimensional mesh via a second feature extraction layer, to obtain a global feature of the object training sample, and perform local feature extraction on the object training sample based on the vertices of the training three-dimensional mesh and the connection relationship between the vertices via a third feature extraction layer, to obtain a local feature of the object training sample.

Operation 205: Perform detection on the keypoint of the object training sample via an output layer based on the vertex feature of the training three-dimensional mesh, the global feature of the object training sample, and the local feature of the object training sample, to obtain a position of the keypoint of the object training sample on the object training sample.

During actual implementation, the three-dimensional network model further includes a first feature splicing layer. Therefore, a process of performing detection on the keypoint of the object training sample via the output layer based on the vertex feature of the training three-dimensional mesh, the global feature of the object training sample, and the local feature of the object training sample, to obtain the position of the keypoint of the object training sample on the object training sample may be: performing feature splicing on the vertex feature of the training three-dimensional mesh, the global feature of the object training sample, and the local feature of the object training sample via the first feature splicing layer, to obtain a spliced feature of the object training sample; and performing detection on the keypoint of the object training sample based on the spliced feature of the object training sample via the output layer, to obtain the position of the keypoint of the object training sample on the object training sample.

Operation 206: Acquire a difference between the position of the keypoint of the object training sample and the label, and train the three-dimensional network model based on the difference, to obtain a target three-dimensional network model, the target three-dimensional network model being configured for performing keypoint detection on a target object, to obtain a position of a keypoint of the target object on the target object.

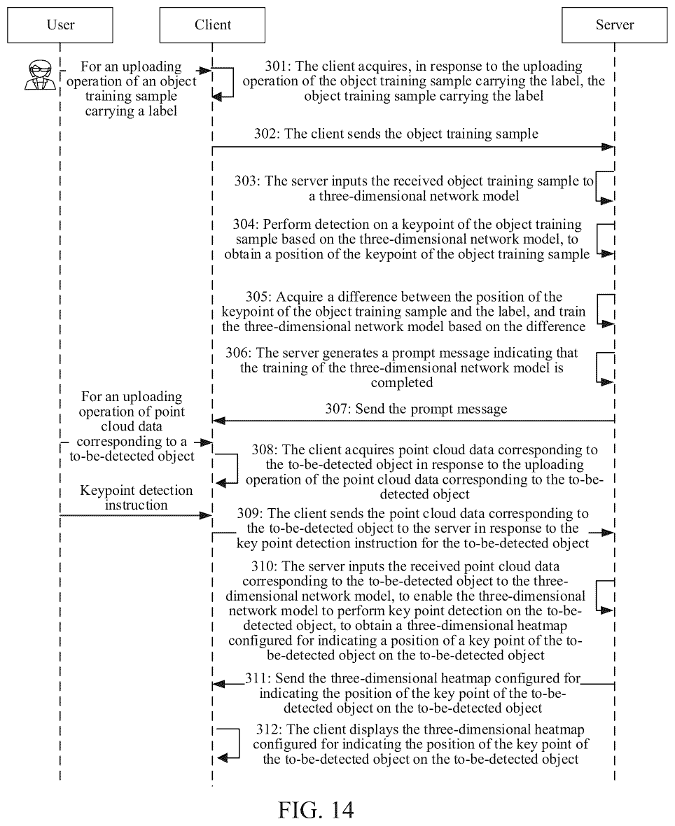

The following continues to describe the keypoint detection method provided in the embodiments of this application. Referring to FIG. 14, FIG. 14 is a schematic flowchart of a keypoint detection method according to an embodiment of this application. Based on FIG. 14, the keypoint detection method provided in the embodiments of this application is cooperatively implemented by a client and a server.

Operation 301: The client acquires, in response to an uploading operation of an object training sample carrying a label, the object training sample carrying the label.

During actual implementation, the client may be a keypoint detection client disposed in a terminal. A user triggers, based on a human-computer interaction interface of the client, an uploading function in the human-computer interaction interface, to enable the client to present an object selection interface on the human-computer interaction interface. The user locally uploads, based on the object selection interface, the object training sample carrying the label from the terminal, so that the client obtains the uploaded object training sample.

In some embodiments, an object training sample may alternatively be captured by a camera communicatively connected to a terminal. After capturing the object training sample, the camera annotates a label on the object training sample, and then transmits an object training sample carrying the label to the terminal, and the object training sample carrying the label is automatically uploaded to the client by the terminal.

Operation 302: The client sends the object training sample to the server.

Operation 303: The server inputs the received object training sample to a three-dimensional network model.

Operation 304: Perform detection on a keypoint of the object training sample based on the three-dimensional network model, to obtain a position of the keypoint of the object training sample.

Operation 305: Acquire a difference between the position of the keypoint of the object training sample and the label, and train the three-dimensional network model based on the difference.

During actual implementation, the server completes training of the three-dimensional network model by iterating the foregoing training process until a loss function converges.

Operation 306: The server generates a prompt message indicating that the training of the three-dimensional network model is completed.

Operation 307: Send the prompt message to the client.

Operation 308: The client acquires point cloud data corresponding to a target object in response to an uploading operation of the point cloud data corresponding to the target object.

During actual implementation, the point cloud data corresponding to the target object may be prestored locally in the terminal, may be acquired from the outside world (such as the Internet), or may be collected in real time, for example, collected in real time by using a three-dimensional scanning apparatus such as a three-dimensional scanner.

Operation 309: The client sends the point cloud data corresponding to the target object to the server in response to a keypoint detection instruction for the target object.

During actual implementation, the keypoint detection instruction for the target object may be automatically generated by the client under a specific trigger condition, where for example, the keypoint detection instruction for the target object is automatically generated after the client acquires the point cloud data corresponding to the target object; may be sent to the client by another device communicatively connected to the terminal; or may be generated after the user triggers a corresponding determining function item based on the human-computer interaction interface of the client.

Operation 310: The server inputs the received point cloud data corresponding to the target object to the three-dimensional network model, to enable the three-dimensional network model to perform keypoint detection on the target object, so as to obtain a three-dimensional heatmap configured for indicating a position of a keypoint of the target object on the target object.

Operation 311: Send the three-dimensional heatmap configured for indicating the position of the keypoint of the target object on the target object to the client.

Operation 312: The client displays the three-dimensional heatmap configured for indicating the position of the keypoint of the target object on the target object.

During actual implementation, the client may display the three-dimensional heatmap in the human-computer interaction interface of the client, may store the three-dimensional heatmap locally in the terminal, may send the three-dimensional heatmap to another device communicatively connected to the terminal, or the like.

Through application of the foregoing embodiments of this application, a three-dimensional mesh corresponding to a target object is obtained, a global feature and a local feature of the target object are separately extracted through construction of a dual-path feature extraction layer based on a vertex feature and a connection relationship between vertices obtained by using the three-dimensional mesh, and then a position of a keypoint on the target object is obtained based on the vertex feature obtained by using the three-dimensional mesh and the global feature and the local feature obtained through extraction. In this way, richer feature information of the target object is extracted via a plurality of feature extraction layers, and then detection is performed on the keypoint of the target object based on the rich feature information, so that accuracy of three-dimensional keypoint detection is significantly improved.

An exemplary application of the embodiments of this application in an actual application scenario is described below.

It is found that keypoint detection of a three-dimensional face character is generally divided into two general types. The first general type is a method based on conventional geometric analysis. Generally, a semantic keypoint of a three-dimensional head model is directly positioned through sharp edge detection, curvature calculation, dihedral angle calculation, normal vector calculation, and some specific geometric rules. For example, it may be assumed that a maximum vertex in a z-direction in a three-dimensional coordinate system is a keypoint at a nose tip. Sharp edge detection is performed below the nose tip, and approximate regions of keypoints at the left and right corners of a mouth may be roughly positioned with reference to a symmetry relationship. The second general type is a method based on deep learning. In this general type of method, basically, a three-dimensional head model is first rendered into a two-dimensional image, and then a two-dimensional convolutional neural network is used to extract a feature, to detect a corresponding keypoint. This type of method may be further divided into different combination methods based on whether to perform multi-view detection and whether to directly regress to a three-dimensional keypoint. For example, a common combination method is to render only a front view of the three-dimensional head model and record a rendering projection relationship, then detect two-dimensional keypoint coordinates on the two-dimensional front view, and finally perform backward projection, based on the known projection relationship, into a three-dimensional space, to obtain final three-dimensional keypoint coordinates. Another combination method is to render a plurality of views (for example, a front view and a side view), and respectively input rendered views into different branches of a neural network model, so that the neural network model directly regresses to three-dimensional keypoint coordinates with reference to features of the two views.

However, for the foregoing first type of method, a conventional keypoint positioning method based on the geometric analysis relies on manually set rules. For example, during sharp edge detection, a threshold needs to be specified. This is an empirical value, and is difficult to be applied to head models of different forms. Therefore, robustness of the method is poor. For the foregoing second type of method, the method based on the two-dimensional convolutional neural network has been successful in a conventional two-dimensional image keypoint detection task. However, there are a plurality of restrictions and disadvantages in directly applying the two-dimensional convolutional neural network to three-dimensional keypoint detection. Specifically, first, a quantity of three-dimensional face models that can be acquired is exceedingly less than that of face images. In other words, a dataset is lacking, and therefore it is difficult to make the neural network efficient. Second, in a manner of rendering the three-dimensional face head model into the two-dimensional image, three-dimensional geometric information is inevitably lost. For example, for the front view, information about back of a head is inevitably lacking. If it is necessary to perform detection on a keypoint of the back of the head, when the information is lost, the detection cannot be performed. Third, if a multi-view manner is used to avoid a problem of information loss as much as possible, features are extracted through a multi-branch network, and finally the neural network performs fusion and regression to three-dimensional coordinates. In this way, the neural network needs to learn of intrinsic connections between different views, and there may be a problem of convergence difficulty, thereby increasing training difficulty.

Based on this, the embodiments of this application provide a keypoint detection method, an apparatus, an electronic device, a computer-readable storage medium, and a computer program product, to effectively resolve a plurality of disadvantages of the foregoing technical methods. Specifically, first, a three-dimensional face model dataset is enhanced through patch simplification and patch densification, so that a problem of lack of the three-dimensional head model dataset is resolved, and supervised deep learning is provided with a guarantee of training data. Second, based on a graph neural network structure, a convolutional neural module is directly applied to a three-dimensional space. This avoids a problem of naturally losing three-dimensional geometric information according to the method of performing detection in a two-dimensional space of rendered views, and also resolves a problem that intrinsic connections of different views are difficult to learn of. Finally, a two-dimensional heatmap in a traditional sense is expanded into a three-dimensional heatmap. In comparison with a manner of directly regressing to three-dimensional coordinates, the three-dimensional heatmap can better ensure local accuracy of a detection result.

Next, the technical solutions of this application are described from a product side. Herein, this application provides a three-dimensional face keypoint detection method that is based on a graph neural network structure and a three-dimensional heatmap. This method may be integrated into a character animation tool set, to complete a transformation matching process between different head models in cooperation with a non-rigid registration algorithm. A specific product form herein may be a control. In response to a triggering operation for the control, a keypoint detection request carrying related data of a to-be-detected three-dimensional head model is sent to a remote server deployed with the technical solutions of this application, to acquire a return result. Herein, a manner in which the remote server is deployed facilitates iterative algorithm optimization, and there is no need to update local plug-in code, thereby saving local computer resources.

Next, the technical solutions of this application are described below on a technical side.

First, a graph convolutional neural network structure in the technical solutions of this application is described. Specifically, a three-dimensional model (three-dimensional network model) naturally has a graph structural relationship, and in the relationship, pixels are not as compactly and regularly arranged as in a two-dimensional image. Therefore, it is inappropriate to directly use a traditional convolutional neural network, and a classic graph attention network (GAT) is introduced herein. Herein, for a GAT basic network included in the graph convolutional neural network structure, as shown in Formula (1), it is assumed that a graph structure (three-dimensional mesh) includes N nodes (vertices), where a feature vector (vertex feature) of each node is h, and a dimension of each node is F. Then, it is assumed that a node j is a neighbor of a node i (in other words, there is an edge connection relationship between i and j). In this case, importance (a correlation value) of the node j to the node i may be calculated by using an attention mechanism, as shown in Formula (2) and Formula (3). Specifically, a process of calculating the importance of the node j to the node i by using the attention mechanism may be: performing splicing on features Whᵢ and Whⱼ of the nodes i and j; calculating an inner product of the feature obtained through splicing and a weight vector a with a dimension of 2F, as shown in Formula (4); and determining, based on the importance of the node j to the node i, a feature vector (local feature) of the node i, as shown in Formula (6).

During actual application, K feature vectors (local subfeatures) corresponding to the node i may alternatively be obtained in a multi-layer GAT splicing manner, in other words, by using K attention mechanisms, and the K feature vectors are spliced, to obtain a final feature vector (local feature) corresponding to the node i, as shown in Formula (7). In this way, based on a GAT feature of relying on only an edge (connection relationship between vertices) rather than a complete graph structure, flexibility of a keypoint detection process is improved. In addition, an attention mechanism is used, so that different weights can be assigned to different neighbor nodes, thereby improving accuracy of the keypoint detection process.

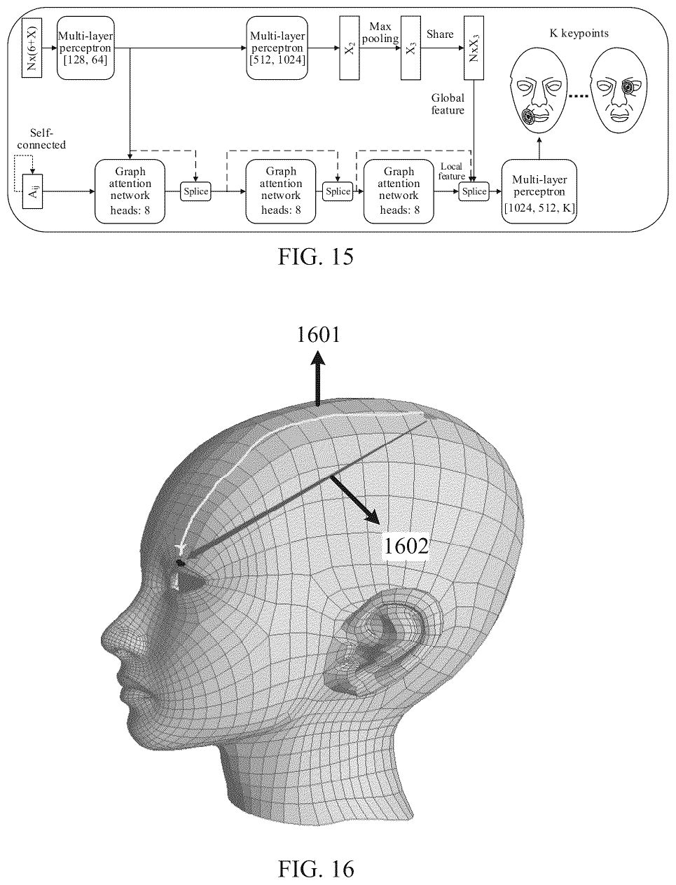

Herein, after descriptions of the graph attention network (GAT), referring to FIG. 15, FIG. 15 is a schematic structural diagram of a graph convolutional neural network according to an embodiment of this application. Herein, a three-dimensional head model keypoint automatic detection neural network shown in FIG. 15 is constructed based on the GAT. Based on FIG. 15, input data, namely, vertex data is N*(6+X) (vertices of a three-dimensional mesh), N represents a quantity of vertices of a three-dimensional model (three-dimensional mesh), 6 represents dimensions occupied by vertex coordinates and a normal vector, and X includes other characteristics of the vertices of the three-dimensional head model (three-dimensional mesh), including a curvature, texture information, and the like. Herein, these other characteristics may be adjusted based on different data and tasks. Generally, richer input characteristics are more beneficial to learning of the neural network. Aᵢⱼ is a vertex connection relationship matrix (connection relationship between the vertices), and has a size of N*N. A value of Aᵢⱼ is 0 or 1. For example, if two vertices i and j are connected, Aᵢⱼ is 1, or otherwise, is 0.

Based on FIG. 15, a multi-layer perceptron (MLP) represents a plurality of fully-connected perceptual layers. The vertex data (vertices of the three-dimensional mesh) first passes through an MLP module with a hidden layer dimension of [128, 64], to obtain a preliminary hidden layer feature X₁ (vertex feature). Then the vertex data is divided into two paths (global feature extraction and local feature extraction). One path continues to pass through an MLP module ([512, 1024]), max pooling is performed on an output feature X₂, to acquire global feature information X₃, and then the global feature information is shared by all N vertices, to determine a global feature N×X₃. The other path passes through three groups of GAT modules. Each GAT module includes eight layers of attention base networks (heads). Herein, output layers of the three groups of GAT modules are spliced together to determine a local feature. Finally, the two paths of features are spliced and inputted into a final MLP module ([1024, 512, K]), to obtain final three-dimensional heatmap data of N*K (K is a quantity of keypoints), and the data is visualized on the three-dimensional head model, to obtain N three-dimensional heatmaps.

Because characteristics of the GAT module and the MLP module, a fixed quantity N of vertices is not needed in a same network structure. This enables three-dimensional face models with different quantities of vertices to be used as input of the neural network model in both a training stage and an actual use stage, thereby improving applicability of this application.

Second, the three-dimensional heatmap in the technical solutions of this application is described. Because a heatmap of a three-dimensional mesh no longer has a structure with compact coordinates of a two-dimensional image, in comparison with a two-dimensional heatmap using a Euclidean distance, the three-dimensional heatmap uses a geodesic distance herein. In this way, on a three-dimensional mesh level, in comparison with a Euclidean distance between two points, verifying a shortest path on a mesh graph structure based on a geodesic distance between two points can better indicates a characteristic of a three-dimensional surface. For example, referring to FIG. 16, FIG. 16 is a comparison diagram of a geodesic distance and a Euclidean distance according to an embodiment of this application. Based on FIG. 16, a straight line between two vertices as indicated by 1602 is the Euclidean distance, and a curve as indicated by 1601 is the corresponding geodesic distance.

When a graph neural network is trained and put into use, the three-dimensional heatmap outputted by the neural network needs to be further transformed into final three-dimensional keypoint coordinates. Herein, a manner of transforming the conventional two-dimensional heatmap into two-dimensional coordinates includes the following operations: Coordinates of a vertex at which a maximum probability is located are first acquired (referred to as an argmax method). Then softmax probability expectations of a plurality of vertex coordinates are weighted (that is, a soft-argmax method), to obtain final three-dimensional keypoint coordinates. For this application, considering that a plurality of three-dimensional coordinates are weighted according to the soft-argmax method, a result does not necessarily fall on a three-dimensional mesh plane. Therefore, the argmax method is directly used herein, in other words, coordinates of a vertex at which a maximum probability is located are acquired, to determine final three-dimensional keypoint coordinates.

Finally, the data enhancement method in this application is described.

Different from a two-dimensional face image and two-dimensional keypoint data, three-dimensional face mesh data is excessively difficult to acquire in a large number. Lack of data is a major problem that plagues supervised neural network learning. A graph neural network can learn sufficient detection capabilities from the dataset only if a dataset is large enough and can cover different face forms. However, a three-dimensional face keypoint dataset is difficult to acquire, a cause of which is shown in the following several aspects. Specifically, first, the three-dimensional face mesh data is produced by the art staff, and a production process is cumbersome. However, generation of a two-dimensional image only needs clicking a camera shutter once. Therefore, in datasets disclosed in either the Internet or academia, two-dimensional face images are rich, and corresponding three-dimensional face data is lacking. Second, for a keypoint detection task, manual annotation needs to be performed on a keypoint in advance (or annotation is implemented through both initial automatic detection by an algorithm and the little number of subsequent manual correction). Two-dimensional keypoint annotation work has been previously performed by the large number of people, and an annotation tool is not complex. Essentially, only a specific pixel in an image needs to be annotated in the work. However, keypoint annotation of a three-dimensional mesh is more difficult. For example, it is difficult for an annotator to confirm a face contour. Therefore, when the three-dimensional data is lacking, it is not possible to develop a corresponding annotation tool based on an existing three-dimensional face head model, to manually annotate a three-dimensional keypoint. Based on this, in the technical solutions of this application, data enhancement is performed on existing three-dimensional face model data based on patch simplification and patch densification, thereby providing normalized and reasonable training data for the graph neural network.

Herein, the data enhancement method is divided into the patch simplification and the patch densification. For the patch simplification, an edge optimization manner may be used, to be specific, the smallest edge between nodes is found each time, and two nodes corresponding to the smallest edge are merged into one vertex, as shown in FIG. 12. For the patch densification, barycentric coordinates are preferentially calculated for a patch with a large area, and then the original triangular patch is divided into three parts based on the barycentric coordinates, as shown in FIG. 13. Herein, termination of operations of both the patch densification and the patch simplification can be controlled by using a final quantity of target vertices.

In this way, in this application, a specific keypoint of a three-dimensional game head model is automatically detected, so that an accurate and reliable keypoint basis can be provided for subsequent registration work of the three-dimensional head model. In comparison with a conventional manner of manual annotation and then performing head model registration, according to this application, excessive manual participation can be avoided, so that keypoint dependent work such as registration of the three-dimensional head model can be automatically completed. This reduces human resources of the art staff, thereby speeding up an entire production process related to animation of a model character.

Further, in this application, based on supervised deep learning of a graph neural network, a position of the three-dimensional keypoint can be accurately predicted, which is robust. In addition, a forward calculation speed of a deep learning model is extremely fast. An algorithm requires only one second on the whole to complete automatic annotation, while in contrast, a manual manner usually takes several minutes. Therefore, this application has great practical value in terms of efficiency. In addition, a quantity of inputted vertices of a three-dimensional face model is not limited in this application. After supervised learning training is performed, the generated deep learning model can be widely applied to tasks of automatic detection of keypoints of three-dimensional head models with different vertex densification degrees, and has strong applicability.

Through application of the foregoing embodiments of this application, a three-dimensional mesh corresponding to a target object is obtained, a global feature and a local feature of the target object are separately extracted through construction of a dual-path feature extraction layer based on a vertex feature and a connection relationship between vertices obtained by using the three-dimensional mesh, and then a position of a keypoint on the target object is obtained based on the vertex feature obtained by using the three-dimensional mesh and the global feature and the local feature obtained through extraction. In this way, richer feature information of the target object is extracted via a plurality of feature extraction layers, and then detection is performed on the keypoint of the target object based on the rich feature information, so that accuracy of three-dimensional keypoint detection is significantly improved.

The following continues to describe an exemplary structure in which an implementation of the keypoint detection apparatus 455 provided in the embodiments of this application is a software module. In some embodiments, as shown in FIG. 2, the software module in the keypoint detection apparatus 455 stored in the memory 450 may include:
an obtaining module 4551, configured to obtain a three-dimensional mesh configured for representing a target object, and determine vertices of the three-dimensional mesh and a connection relationship between the vertices;
a first feature extraction module 4552, configured to perform feature extraction on the vertices of the three-dimensional mesh, to obtain a vertex feature of the three-dimensional mesh; and
a second feature extraction module 4553, configured to perform global feature extraction on the target object based on the vertex feature, to obtain a global feature of the target object, and perform local feature extraction on the target object based on the vertex feature and the connection relationship between the vertices, to obtain a local feature of the target object; and
an output module 4554, configured to perform detection on a keypoint of the target object based on the vertex feature, the global feature, and the local feature, to obtain a position of the keypoint of the target object on the target object.

In some embodiments, the obtaining module 4551 is further configured to scan the target object by using a three-dimensional scanning apparatus, to obtain point cloud data of a geometric surface of the target object; and construct the three-dimensional mesh corresponding to the target object based on the point cloud data.

In some embodiments, the second feature extraction module 4553 is further configured to determine a local feature of each of the vertices based on the vertex feature and the connection relationship between the vertices; and determine the local feature of the target object based on the local feature of each of the vertices.

In some embodiments, the second feature extraction module 4553 is further configured to perform the following processing for each of the vertices: determining the vertex as a reference vertex, and determining a vertex feature of the reference vertex and a vertex feature of another vertex based on a vertex feature of each vertex in the three-dimensional mesh; the another vertex being any vertex other than the reference vertex; determining a correlation value between the reference vertex and the another vertex based on the vertex feature of the reference vertex, the vertex feature of the another vertex, and the connection relationship between the vertices, the correlation value being configured for indicating a magnitude of a correlation degree between the reference vertex and the another vertex; and determining a local feature of the reference vertex based on the correlation value and the vertex feature of the another vertex.

In some embodiments, the second feature extraction module 4553 is further configured to determine the correlation degree between the reference vertex and the another vertex by using an attention mechanism based on the vertex feature of the reference vertex, the vertex feature of the another vertex, and the connection relationship between the vertices; and perform normalization processing on the correlation degree, to obtain the correlation value between the reference vertex and the another vertex.

In some embodiments, when a quantity of other vertices is one, the second feature extraction module 4553 is further configured to perform multiplication on the correlation value and the vertex feature of another vertex, to obtain a multiplication result; and determine the local feature corresponding to the reference vertex based on the multiplication result.

In some embodiments, when a quantity of other vertices is more than one, the second feature extraction module 4553 is further configured to perform, for each of the other vertices, multiplication on the correlation value and a vertex feature of the another corresponding vertex, to obtain a multiplication result of the another vertex; perform cumulative summation on multiplication results of the other vertices, to obtain a summation result; and determine the local feature corresponding to the reference vertex based on the summation result.

In some embodiments, the second feature extraction module 4553 is further configured to perform feature fusion on the local feature of each of the vertices based on the local feature of each of the vertices, to obtain a fused feature; and use the fused feature as the local feature of the target object.

In some embodiments, the output module 4554 is further configured to perform feature splicing on the vertex feature, the global feature, and the local feature, to obtain a spliced feature of the target object; and perform detection on the keypoint of the target object based on the spliced feature, to obtain the position of the keypoint of the target object on the target object.

In some embodiments, the output module 4554 is further configured to perform detection on the keypoint of the target object based on the vertex feature, the global feature, and the local feature, to obtain a probability of the keypoint being at each of the vertices in the three-dimensional mesh; generate a three-dimensional heatmap corresponding to the three-dimensional mesh based on the probability; and determine the position of the keypoint of the target object on the target object based on the three-dimensional heatmap.

In some embodiments, the apparatus is used in a three-dimensional network model. The three-dimensional network model includes at least a first feature extraction layer, a second feature extraction layer, a third feature extraction layer, and an output layer. The first feature extraction module 4552 is further configured to perform feature extraction on the vertices of the three-dimensional mesh via the first feature extraction layer, to obtain the vertex feature of the three-dimensional mesh. The second feature extraction module 4553 is further configured to perform global feature extraction on the target object based on the vertex feature via the second feature extraction layer, to obtain the global feature of the target object, and perform local feature extraction on the target object based on the vertex feature and the connection relationship between the vertices via the third feature extraction layer, to obtain the local feature of the target object. The output module 4554 is further configured to perform detection on the keypoint of the target object via the output layer based on the vertex feature, the global feature, and the local feature, to obtain the position of the keypoint of the target object on the target object.

In some embodiments, the three-dimensional network model further includes a first feature splicing layer, a second feature splicing layer, and a fourth feature extraction layer. The output module 4554 is further configured to perform feature splicing on the vertex feature, the global feature, and the local feature via the first feature splicing layer, to obtain the spliced feature of the target object; perform local feature extraction on the target object based on the spliced feature via the fourth feature extraction layer, to obtain a target local feature of the target object; perform feature splicing on the spliced feature, the global feature, and the target local feature via the second feature splicing layer, to obtain a target spliced feature of the target object; and perform detection on the keypoint of the target object based on the target spliced feature via the output layer, to obtain the position of the keypoint of the target object on the target object.

The following continues to describe an exemplary structure in which an implementation of an apparatus for training a three-dimensional network model provided in the embodiments of this application is a software module. The three-dimensional network model includes at least a first feature extraction layer, a second feature extraction layer, a third feature extraction layer, and an output layer. The training apparatus includes:
an acquiring module, configured to acquire an object training sample carrying a label, the label being configured for indicating a real position of a keypoint of the object training sample;
an obtaining module, configured to obtain a training three-dimensional mesh configured for representing the object training sample, and determine vertices of the training three-dimensional mesh and a connection relationship between the vertices;
a first feature extraction module, configured to perform feature extraction on the vertices of the object training sample via the first feature extraction layer, to obtain a vertex feature of the training three-dimensional mesh;
a second feature extraction module, configured to perform global feature extraction on the object training sample based on the vertex feature of the training three-dimensional mesh via the second feature extraction layer, to obtain a global feature of the object training sample, and perform local feature extraction on the object training sample based on the vertices of the training three-dimensional mesh and the connection relationship between the vertices via the third feature extraction layer, to obtain a local feature of the object training sample;
an output module, configured to perform detection on the keypoint of the object training sample via the output layer based on the vertex feature of the training three-dimensional mesh, the global feature of the object training sample, and the local feature of the object training sample, to obtain a position of the keypoint of the object training sample on the object training sample; and
an update module, configured to acquire a difference between the position of the keypoint of the object training sample and the label, and train the three-dimensional network model based on the difference, to obtain a target three-dimensional network model, the target three-dimensional network model being configured for performing keypoint detection on a target object, to obtain a position of a keypoint of the target object on the target object.

An embodiment of this application further provides an electronic device, including:
a memory, configured to store computer-executable instructions; and
a processor, configured to implement, when executing the computer-executable instructions stored in the memory, the keypoint detection method or the method for training a three-dimensional network model in the embodiments of this application, for example, the keypoint detection method shown in FIG. 3, or the method for training a three-dimensional network model shown in FIG. 11.

An embodiment of this application provides a computer program product or a computer program. The computer program product or the computer program includes computer-executable instructions. The computer-executable instructions are stored in a computer-readable storage medium. A processor of an electronic device reads the computer-executable instructions from the computer-readable storage medium, and the processor executes the computer-executable instructions, to cause the electronic device to perform the keypoint detection method or the method for training a three-dimensional network model in the embodiments of this application, for example, the keypoint detection method shown in FIG. 3 or the method for training a three-dimensional network model shown in FIG. 11.

An embodiment of this application provides a computer-readable storage medium, having computer-executable instructions stored therein. When the computer-executable instructions are executed by a processor, the processor performs the keypoint detection method or the method for training a three-dimensional network model provided in the embodiments of this application, for example, the keypoint detection method shown in FIG. 3 or the method for training a three-dimensional network model shown in FIG. 11.

In some embodiments, the computer-readable storage medium may be a memory such as an FRAM, a ROM, a PROM, an EPROM, an EEPROM, a flash memory, a magnetic surface memory, a compact disc, or a CD-ROM, or may be various devices including one or any combination of the foregoing memories.

In some embodiments, the computer-executable instruction may be written in any form of programming language (including a compiled or interpreted language, or a declarative or procedural language) in the form of a program, software, a software module, a script, or code, and may be deployed in any form, including being deployed as an independent program or being deployed as a module, a component, a subroutine, or another unit suitable for use in a computing environment.

In an example, the computer-executable instruction may but do not necessarily correspond to a file in a file system, may be stored in a part of a file for storing another program or other data, for example, stored in one or more scripts in a hypertext markup language (HTML) document, in a single file specifically configured for a discussed program, or in a plurality of collaborative files (for example, files storing one or more modules, a subprogram, or a code part).

In an example, the executable instruction may be deployed to be executed on one electronic device, executed on a plurality of electronic devices located at one position, or executed on a plurality of electronic devices distributed at a plurality of positions and interconnected through a communication network.

In conclusion, the embodiments of this application have the following beneficial effects:

(1) Richer feature information of a target object is extracted via a plurality of feature extraction layers, and then detection is performed on a keypoint of the target object based on the rich feature information, so that accuracy of three-dimensional keypoint detection is significantly improved.

(2) A GAT feature of relying on only an edge rather than a complete graph structure is used, so that flexibility of a keypoint detection process is improved. In addition, an attention mechanism is used, so that different weights can be assigned to different neighbor nodes, thereby improving accuracy of the keypoint detection process.

(3) A specific keypoint of a three-dimensional game head model is automatically detected, so that an accurate and reliable keypoint basis can be provided for subsequent registration work of the three-dimensional head model. In comparison with a conventional manner of manual annotation and then performing head model registration, according to this application, excessive manual participation can be avoided, so that keypoint dependent work such as registration of the three-dimensional head model can be automatically completed. This reduces human resources of the art staff, thereby speeding up an entire production process related to animation of a model character.

(4) Based on supervised deep learning of a graph neural network, a position of the three-dimensional keypoint can be accurately predicted, which is robust. In addition, a forward calculation speed of a deep learning model is extremely fast. An algorithm requires only one second on the whole to complete automatic annotation, while in contrast, a manual manner usually takes several minutes. Therefore, this application has great practical value in terms of efficiency. In addition, a quantity of inputted vertices of a three-dimensional face model is not limited in this application. After supervised learning training is performed, the generated deep learning model can be widely applied to tasks of automatic detection of keypoints of three-dimensional head models with different vertex densification degrees, and has strong applicability.

In sum, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of multiple sub-modules. The foregoing descriptions are merely the embodiments of this application, and are not intended to limit the protection scope of this application. Any modification, equivalent replacement, or improvement made without departing from the spirit and principle of this application shall fall within the protection scope of this application.

What is claimed is:

1. A keypoint detection method performed by an electronic device, the method comprising:
obtaining a three-dimensional mesh configured for representing a target object;
performing feature extraction on vertices of the three-dimensional mesh, to obtain a vertex feature of the three-dimensional mesh;
performing global feature extraction on the target object based on the vertex feature, to obtain a global feature of the target object, and performing local feature extraction on the target object based on the vertex feature and connection relationship between the vertices, to obtain a local feature of the target object; and
obtaining a position of a keypoint of the target object on the target object based on the vertex feature, the global feature, and the local feature.

2. The method according to claim 1, wherein the obtaining a three-dimensional mesh configured for representing a target object comprises:
scanning the target object by using a three-dimensional scanning apparatus, to obtain point cloud data of a geometric surface of the target object; and
constructing the three-dimensional mesh corresponding to the target object based on the point cloud data.

3. The method according to claim 1, wherein the performing local feature extraction on the target object based on the vertex feature and connection relationship between the vertices, to obtain a local feature of the target object comprises:
determining a local feature of each of the vertices based on the vertex feature and the connection relationship between the vertices; and
determining the local feature of the target object based on the local feature of each of the vertices.

4. The method according to claim 3, wherein the determining a local feature of each of the vertices based on the vertex feature and the connection relationship between the vertices comprises:
determining the vertex as a reference vertex, and determining a vertex feature of the reference vertex and a vertex feature of another vertex based on a vertex feature of each vertex in the three-dimensional mesh, the another vertex being any vertex other than the reference vertex;
determining a correlation value between the reference vertex and the another vertex based on the vertex feature of the reference vertex, the vertex feature of the another vertex, and the connection relationship between the vertices, the correlation value being configured for indicating a magnitude of a correlation degree between the reference vertex and the another vertex; and
determining a local feature of the reference vertex based on the correlation value and the vertex feature of the another vertex.

5. The method according to claim 3, wherein the determining the local feature of the target object based on the local feature of each of the vertices comprises:
performing feature fusion on the local feature of each of the vertices based on the local feature of each of the vertices, to obtain a fused feature; and
using the fused feature as the local feature of the target object.

6. The method according to claim 1, wherein the obtaining a position of a keypoint of the target object on the target object based on the vertex feature, the global feature, and the local feature comprises:
performing feature splicing on the vertex feature, the global feature, and the local feature, to obtain a spliced feature of the target object; and
performing detection on the keypoint of the target object based on the spliced feature, to obtain the position of the keypoint of the target object on the target object.

7. The method according to claim 1, wherein the obtaining a position of a keypoint of the target object on the target object based on the vertex feature, the global feature, and the local feature comprises:
performing detection on the keypoint of the target object based on the vertex feature, the global feature, and the local feature, to obtain a probability of the keypoint being at each of the vertices in the three-dimensional mesh;
generating a three-dimensional heatmap corresponding to the three-dimensional mesh based on the probability; and
determining the position of the keypoint of the target object on the target object based on the three-dimensional heatmap.

8. The method according to claim 1, wherein:
the performing feature extraction on vertices of the three-dimensional mesh, to obtain a vertex feature of the three-dimensional mesh comprises:
performing feature extraction on the vertices of the three-dimensional mesh via a first feature extraction layer, to obtain the vertex feature of the three-dimensional mesh;
the performing global feature extraction on the target object based on the vertex feature, to obtain a global feature of the target object, and performing local feature extraction on the target object based on the vertex feature and the connection relationship between the vertices, to obtain a local feature of the target object comprises:
performing global feature extraction on the target object based on the vertex feature via a second feature extraction layer, to obtain the global feature of the target object, and performing local feature extraction on the target object based on the vertex feature and the connection relationship between the vertices via a third feature extraction layer, to obtain the local feature of the target object; and
the obtaining a position of a keypoint of the target object on the target object based on the vertex feature, the global feature, and the local feature comprises:
performing detection on the keypoint of the target object via an output layer based on the vertex feature, the global feature, and the local feature, to obtain the position of the keypoint of the target object on the target object.

9. An electronic device, comprising:
a processor;
a memory; and
a plurality of computer-executable instructions stored in the memory that, when executed by the processor, cause the electronic device to perform a keypoint detection method including:
obtaining a three-dimensional mesh configured for representing a target object;
performing feature extraction on vertices of the three-dimensional mesh, to obtain a vertex feature of the three-dimensional mesh;
performing global feature extraction on the target object based on the vertex feature, to obtain a global feature of the target object, and performing local feature extraction on the target object based on the vertex feature and connection relationship between the vertices, to obtain a local feature of the target object; and
obtaining a position of a keypoint of the target object on the target object based on the vertex feature, the global feature, and the local feature.

10. The electronic device according to claim 9, wherein the obtaining a three-dimensional mesh configured for representing a target object comprises:
scanning the target object by using a three-dimensional scanning apparatus, to obtain point cloud data of a geometric surface of the target object; and
constructing the three-dimensional mesh corresponding to the target object based on the point cloud data.

11. The electronic device according to claim 9, wherein the performing local feature extraction on the target object based on the vertex feature and connection relationship between the vertices, to obtain a local feature of the target object comprises:
determining a local feature of each of the vertices based on the vertex feature and the connection relationship between the vertices; and
determining the local feature of the target object based on the local feature of each of the vertices.

12. The electronic device according to claim 11, wherein the determining a local feature of each of the vertices based on the vertex feature and the connection relationship between the vertices comprises:
determining the vertex as a reference vertex, and determining a vertex feature of the reference vertex and a vertex feature of another vertex based on a vertex feature of each vertex in the three-dimensional mesh, the another vertex being any vertex other than the reference vertex;
determining a correlation value between the reference vertex and the another vertex based on the vertex feature of the reference vertex, the vertex feature of the another vertex, and the connection relationship between the vertices, the correlation value being configured for indicating a magnitude of a correlation degree between the reference vertex and the another vertex; and
determining a local feature of the reference vertex based on the correlation value and the vertex feature of the another vertex.

13. The electronic device according to claim 11, wherein the determining the local feature of the target object based on the local feature of each of the vertices comprises:
performing feature fusion on the local feature of each of the vertices based on the local feature of each of the vertices, to obtain a fused feature; and
using the fused feature as the local feature of the target object.

14. The electronic device according to claim 9, wherein the obtaining a position of a keypoint of the target object on the target object based on the vertex feature, the global feature, and the local feature comprises:
performing feature splicing on the vertex feature, the global feature, and the local feature, to obtain a spliced feature of the target object; and
performing detection on the keypoint of the target object based on the spliced feature, to obtain the position of the keypoint of the target object on the target object.

15. The electronic device according to claim 9, wherein the obtaining a position of a keypoint of the target object on the target object based on the vertex feature, the global feature, and the local feature comprises:
performing detection on the keypoint of the target object based on the vertex feature, the global feature, and the local feature, to obtain a probability of the keypoint being at each of the vertices in the three-dimensional mesh;
generating a three-dimensional heatmap corresponding to the three-dimensional mesh based on the probability; and
determining the position of the keypoint of the target object on the target object based on the three-dimensional heatmap.

16. The electronic device according to claim 9, wherein:
the performing feature extraction on vertices of the three-dimensional mesh, to obtain a vertex feature of the three-dimensional mesh comprises:
performing feature extraction on the vertices of the three-dimensional mesh via a first feature extraction layer, to obtain the vertex feature of the three-dimensional mesh;
the performing global feature extraction on the target object based on the vertex feature, to obtain a global feature of the target object, and performing local feature extraction on the target object based on the vertex feature and the connection relationship between the vertices, to obtain a local feature of the target object comprises:
performing global feature extraction on the target object based on the vertex feature via a second feature extraction layer, to obtain the global feature of the target object, and performing local feature extraction on the target object based on the vertex feature and the connection relationship between the vertices via a third feature extraction layer, to obtain the local feature of the target object; and
the obtaining a position of a keypoint of the target object on the target object based on the vertex feature, the global feature, and the local feature comprises:
performing detection on the keypoint of the target object via an output layer based on the vertex feature, the global feature, and the local feature, to obtain the position of the keypoint of the target object on the target object.

17. A non-transitory computer-readable storage medium, having computer-executable instructions stored therein, the computer-executable instructions, when executed by a processor of an electronic device, causing the electronic device to perform a keypoint detection method including:
obtaining a three-dimensional mesh configured for representing a target object;
performing feature extraction on vertices of the three-dimensional mesh, to obtain a vertex feature of the three-dimensional mesh;
performing global feature extraction on the target object based on the vertex feature, to obtain a global feature of the target object, and performing local feature extraction on the target object based on the vertex feature and connection relationship between the vertices, to obtain a local feature of the target object; and
obtaining a position of a keypoint of the target object on the target object based on the vertex feature, the global feature, and the local feature.

18. The non-transitory computer-readable storage medium according to claim 17, wherein the obtaining a three-dimensional mesh configured for representing a target object comprises:
scanning the target object by using a three-dimensional scanning apparatus, to obtain point cloud data of a geometric surface of the target object; and
constructing the three-dimensional mesh corresponding to the target object based on the point cloud data.

19. The non-transitory computer-readable storage medium according to claim 17, wherein the performing local feature extraction on the target object based on the vertex feature and connection relationship between the vertices, to obtain a local feature of the target object comprises:
determining a local feature of each of the vertices based on the vertex feature and the connection relationship between the vertices; and
determining the local feature of the target object based on the local feature of each of the vertices.

20. The non-transitory computer-readable storage medium according to claim 17, wherein the obtaining a position of a keypoint of the target object on the target object based on the vertex feature, the global feature, and the local feature comprises:
performing feature splicing on the vertex feature, the global feature, and the local feature, to obtain a spliced feature of the target object; and
performing detection on the keypoint of the target object based on the spliced feature, to obtain the position of the keypoint of the target object on the target object.
